(19) United States
(12) Patent Application Publication
(10) Pub. No.: US 2019/0237994 A1
(43) Pub. Date: Aug. 1, 2019

(54) UNINTERRUPTIBLE POWER SUPPLY

(71) Applicant: Fuji Electric Co., Ltd., Kanagawa (JP)

(72) Inventor: Masao TAKEUCHI, Hyogo (JP)

(73) Assignee: Fuji Electric Co., Ltd., Kanagawa (JP)

(21) Appl. No.: 16/213,374

(22) Filed: Dec. 7, 2018

(30) Foreign Application Priority Data
Jan. 26, 2018 (JP) 2018-011756

(51) Int. Cl. H02J 9/06; H02J 7/00

(52) U.S. Cl. CPC H02J 9/062; H02J 7/345; H02J 7/0052

(57) ABSTRACT

An uninterruptible power supply includes a converter, an inverter, a DC link circuit arranged between the converter and the inverter, a battery, a switch arranged between an AC power supply and the converter, an input filter capacitor connected between the switch and the converter, and an initial charging circuit which is connected in parallel to the switch and the converter and charges a DC link capacitor in the DC link circuit. The uninterruptible power supply further includes a controller which, during startup, causes the converter to convert DC voltage from the battery to AC voltage so as to charge the input filter capacitor.

### BACKGROUND OF THE INVENTION

### Technical Field

The present invention relates to an uninterruptible power supply, and more particularly to an uninterruptible power supply including an input filter capacitor arranged between an AC power supply and a converter.

### Background Art

Uninterruptible power supplies which include an input filter capacitor arranged between an AC power supply and a converter are conventionally well-known (see Patent Document 1, for example).

The uninterruptible power supply of Patent Document 1 includes a converter which converts an AC voltage from an AC power supply to a DC voltage, an inverter which converts the DC voltage from the converter to an AC voltage, and a storage battery which supplies a DC voltage to the inverter when the AC power supply suffers an outage. Moreover, an AC input switch and an AC filter capacitor (an input filter capacitor) are arranged between the AC power supply and the converter. In the uninterruptible power supply described above, when the power supply is reconnected or recovers from an outage, at the moment at which the AC input switch is switched ON, the amplitudes and phases of the excitation voltage of the converter due to the storage battery and the excitation voltage of the AC power supply are controlled so as to be equal. Doing this reduces the inrush current (current exceeding the steady-state current) which flows into the AC filter capacitor when the AC input switch is switched ON.

### RELATED ART DOCUMENT

### Patent Document

Patent Document 1: Japanese Patent Application Laid-Open Publication No. H8-65917

### SUMMARY OF THE INVENTION

However, although this is not explicitly described in Patent Document 1, in a conventional uninterruptible power supply of the type disclosed in Patent Document 1, when the uninterruptible power supply is first turned on, the AC power supply gets connected in a state in which the AC filter capacitor is not yet charged (excited), which can result in undesirable flow of inrush current into the AC filter capacitor. This can affect the operation of the AC power supply itself as well as result in fluctuation in the voltage of the AC power supply due to the impedance of the power supply lines between the AC power supply and the uninterruptible power supply, which in turn affects the operation of any electronic devices connected to the AC power supply.

The present invention was made to solve the abovementioned problems, and one object of the present invention is to provide an uninterruptible power supply which makes it possible to reduce the occurrence of inrush current-induced effects on operation of an AC power supply itself as well as on operation of any electronic devices connected to the AC power supply.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides an uninterruptible power supply, including: a converter that receives an AC voltage from an AC power supply at an input node and converts the AC voltage to a DC voltage; an inverter that converts the DC voltage from the converter to an AC voltage and supplies that AC voltage to a load; a DC link circuit that includes a DC link capacitor and is arranged between the converter and the inverter; an electrical storage unit that is connected to the DC link circuit so as to supply power to the load through the inverter when the AC power supply is abnormal; a first switch arranged between the input node of the converter to be connected to the AC power supply and the converter; an input filter capacitor connected between the first switch and the converter; an initial charging circuit that is connected in parallel to the first switch and the converter to charge the DC link capacitor of the DC link circuit; and a controller that, during startup, turns OFF the first switch, activates the initial charging circuit to initially charge the DC link capacitor, and thereafter activates the converter to convert DC voltage from the electrical storage unit to AC voltage so as to charge the input filter capacitor while the first switch is maintained in an OFF state.

In the uninterruptible power supply according to this aspect of the present invention, as described above, during startup the first switch is switched OFF, the initial charging circuit is used to initially charge the DC link capacitor, and DC voltage from the electrical storage unit is used to charge the input filter capacitor. Therefore, during startup, the input filter capacitor can be charged using the electrical storage unit instead of having to charge the input filter capacitor by using the AC voltage from the AC power supply. As a result, when the AC power supply and the input filter capacitor are connected together by switching ON the first switch, the input filter capacitor has already been charged by the voltage of the electrical storage unit, which makes it possible to reduce the voltage difference between the voltage of the input filter capacitor and the voltage of the AC power supply. This makes it possible to prevent flow of inrush current from the AC power supply to the input filter capacitor when the AC power supply and the input filter capacitor are connected together by switching ON the first switch. This, in turn, makes it possible to prevent the occurrence of inrush current-induced effects on operation of the AC power supply itself as well as on operation of any electronic devices connected to the AC power supply. Here, when the input filter capacitor is charged by the AC voltage, the input filter capacitor is alternately charged and discharged in a repeated, periodic manner. Thus, “charging the input filter capacitor using an AC voltage” refers to this repeated periodic charging.

In the uninterruptible power supply according to the aspect described above, the uninterruptible power supply may further include: a chopper arranged between the DC link circuit and the electrical storage unit, wherein the initial charging circuit includes a charging resistor and a second switch connected in parallel to the charging resistor, and wherein the controller switches ON the second switch and powers on the chopper so that current flows from the AC power supply towards the electrical storage unit. This configuration allows the current that flows when the chopper is powered on to flow more easily through the second switch than through the charging resistor, thereby making it possible to reduce the amount of current that flows through the charging resistor in comparison to when the second switch is not present. This, in turn, makes it possible to prevent damage (burnout) of the charging resistor due to current flowing therethrough.

In this case, the uninterruptible power supply may further include: a third switch arranged between the chopper and the electrical storage unit; and a DC filter capacitor connected between the third switch and the chopper, wherein the controller turns ON the second switch and powers on the chopper to charge the DC filter capacitor, and when the DC filter capacitor has been charged, switches ON the third switch, and the controller thereafter activates the converter to convert DC voltage from the electrical storage unit to AC voltage so as to charge the input filter capacitor. In this configuration, switching ON the third switch only after the DC filter capacitor has been charged makes it possible to prevent flow of inrush current from the electrical storage unit to the DC filter capacitor when the third switch is switched ON. This, in turn, makes it possible to prevent damage (burnout) of the DC filter capacitor.

In the above-described uninterruptible power supply including the chopper, the controller may turn ON the second switch and power on the chopper when a voltage of the DC link capacitor resulting from the initial charging by the initial charging circuit becomes greater than or equal to a prescribed threshold value. This makes it possible to reduce the amount of current that flows through the charging resistor in comparison to when the second switch is not present, thereby making it possible to prevent the charging resistor from being damaged (burnt out) by the current flowing therethrough when the voltage of the DC link capacitor becomes greater than or equal to the prescribed threshold value.

In the above-described uninterruptible power supply including the chopper, the controller may cause the converter and the electrical storage unit to be connected via the chopper, deactivate the initial charging circuit, and activate the converter to convert DC voltage from the electrical storage unit to AC voltage so as to charge the input filter capacitor. In this configuration, setting the initial charging circuit to a non-conducting state makes it possible to prevent the current that flows from the electrical storage unit to the converter from flowing to the AC power supply through the initial charging circuit.

In the uninterruptible power supply according to the aspect described above, when activating the converter to convert the DC voltage from the electrical storage unit to the AC voltage so as to charge the input filter capacitor, the controller may also cause the DC voltage from the electrical storage unit to charge the DC link capacitor. This configuration makes it possible to prevent the charge of the DC link capacitor from decreasing when the input filter capacitor is charged using DC voltage from the DC link capacitor.

In the uninterruptible power supply according to the aspect described above, when activating the converter to convert the DC voltage from the electrical storage unit to the AC voltage so as to charge the input filter capacitor, the controller may cause a phase and amplitude of the AC voltage from the converter that charges the input filter capacitor to be substantially equal to a phase and amplitude of the AC voltage from the AC power supply. In this configuration, the voltage difference (amplitude difference and phase difference) between the AC voltage from the converter (the voltage of the input filter capacitor) and the AC voltage from the AC power supply becomes substantially equal to zero, thereby making it possible to more reliably prevent flow of inrush current from the AC power supply to the input filter capacitor.

In the uninterruptible power supply according to the aspect described above, once the input filter capacitor has been charged, the controller may turn ON the first switch and cause the AC voltage from the AC power supply to charge the electrical storage unit. This configuration makes it possible to prevent inrush current from flowing to the input filter capacitor when the first switch is switched ON, thereby making it possible to prevent the occurrence of any effects on operation of the AC power supply itself. This, in turn, allows the electrical storage unit to be appropriately charged by the AC power supply.

In the uninterruptible power supply according to the aspect described above, when activating the converter to convert the DC voltage from the electrical storage unit to the AC voltage so as to charge the input filter capacitor, the controller may cause a phase and amplitude of the AC voltage from the converter that charges the input filter capacitor to be substantially equal to a phase and amplitude of the AC voltage from the AC power supply, and when the input filter capacitor has been charged and when the phase and amplitude of the AC voltage from the converter that charges the input filter capacitor become substantially equal to the phase and amplitude of the AC voltage from the AC power supply, the controller may turn ON the first switch and cause the AC voltage from the AC power supply to charge the electrical storage unit.

The present invention makes it possible to reduce the occurrence of inrush current-induced effects on operation of an AC power supply itself as well as on operation of any electronic devices connected to the AC power supply.

It is to be understood that both the foregoing general description and the following detailed description are exemplary and explanatory, and are intended to provide further explanation of the invention as claimed.

### BRIEF DESCRIPTION OF THE DRAWINGS

FIG. 1 illustrates the overall configuration of an uninterruptible power supply according to an embodiment of the present invention.

FIG. 2 is a drawing for explaining operation of the uninterruptible power supply according to the embodiment during an initial charging period.

FIG. 3 is a drawing for explaining operation of the uninterruptible power supply according to the embodiment when a second switch is switched ON.

FIG. 4 is a drawing for explaining operation of the uninterruptible power supply according to the embodiment when a chopper is powered on.

FIG. 5 is a drawing for explaining operation of the uninterruptible power supply according to the embodiment when an electrical storage unit is connected to the chopper.

FIG. 6 is a drawing for explaining operation of the uninterruptible power supply according to the embodiment when a converter is powered on.

FIG. 7 is a drawing for explaining operation of the uninterruptible power supply according to the embodiment when a first switch is switched ON.

FIG. 8 is a flowchart for explaining how the uninterruptible power supply according to the embodiment is controlled during startup.

### DETAILED DESCRIPTION OF EMBODIMENTS

Specific embodiments of the present invention will be described below with reference to figures.

### Embodiment

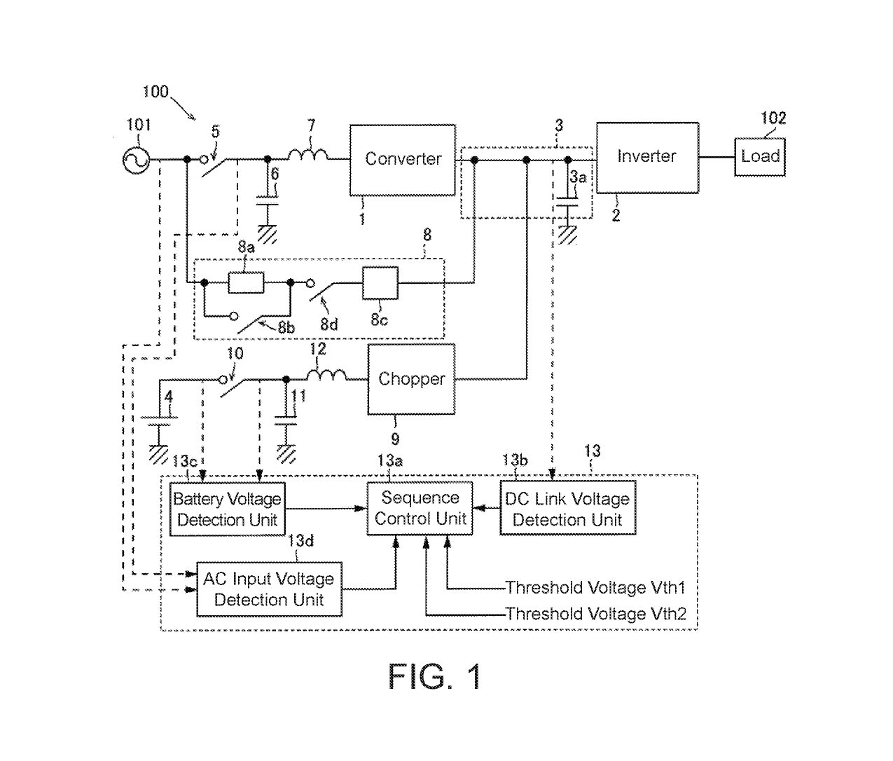

Here, the configuration of an uninterruptible power supply 100 according to an embodiment of the present invention will be described with reference to FIGS. 1 to 8.

(Configuration of Uninterruptible Power Supply)

First, the overall configuration of the uninterruptible power supply 100 will be described with reference to FIG. 1.

As illustrated in FIG. 1, the uninterruptible power supply 100 includes a converter 1 which converts an AC voltage from an AC power supply 101 to a DC voltage. The uninterruptible power supply 100 further includes an inverter 2 which converts the DC voltage from the converter 1 to an AC voltage and then supplies that AC voltage to a load 102. Moreover, the uninterruptible power supply 100 includes a DC link circuit 3 arranged between the converter 1 and the inverter 2. The DC link circuit 3 includes a DC link capacitor 3a for smoothing the DC voltage. Furthermore, the uninterruptible power supply 100 includes a battery 4 connected to the DC link circuit 3. The battery 4 supplies power to the load 102 when the AC power supply 101 is abnormal. Here, the converter 1 and the inverter 2 are a PWM converter and a PWM inverter, respectively. Moreover, the battery 4 is an example of an “electrical storage unit” as recited in the claims.

The uninterruptible power supply 100 further includes a switch 5 arranged between the AC power supply 101 and the converter 1. Furthermore, the uninterruptible power supply 100 includes an input filter capacitor 6 connected between the switch 5 and the converter 1. In addition, an inductor 7 is arranged between the converter 1 and the input filter capacitor 6. Here, the switch 5 is an example of a “first switch” as recited in the claims.

The uninterruptible power supply 100 further includes an initial charging circuit 8 connected in parallel to the switch 5 and the converter 1. The initial charging circuit 8 charges the DC link capacitor 3a of the DC link circuit 3 during startup of the uninterruptible power supply 100. The initial charging circuit 8 includes a charging resistor 8a. The initial charging circuit 8 further includes a switch 8b connected in parallel to the charging resistor 8a. Furthermore, the initial charging circuit 8 includes a rectifier 8c connected in series to the charging resistor 8a and a switch 8d arranged between the rectifier 8c and the AC power supply 101. The rectifier 8c converts the AC voltage from the AC power supply 101 to a DC voltage. The switch 8d is arranged between the charging resistor 8a and the rectifier 8c. Here, the switch 8b is an example of a “second switch” as recited in the claims.

The uninterruptible power supply 100 further includes a chopper 9 arranged between the DC link circuit 3 and the battery 4. The chopper 9 is configured to step up or step down the DC voltage input thereto.

The uninterruptible power supply 100 further includes a switch 10 arranged between the chopper 9 and the battery 4. Furthermore, the uninterruptible power supply 100 includes a DC filter capacitor 11 connected between the switch 10 and the chopper 9. In addition, an inductor 12 is arranged between the DC filter capacitor 11 and the chopper 9. The DC filter capacitor 11 and the inductor 12 are provided to remove ripples in the DC voltage between the battery 4 and the chopper 9. Here, the switch 10 is an example of a “third switch” as recited in the claims.

Moreover, the switch 5, the switch 8b, the switch 10, and the switch 8d are magnetic contactors.

The uninterruptible power supply 100 further includes a controller 13. The controller 13 includes a sequence control unit 13a, a DC link voltage detection unit 13b, a battery voltage detection unit 13c, and an AC input voltage detection unit 13d. In the controller 13, the respective functions of the sequence control unit 13a, the DC link voltage detection unit 13b, the battery voltage detection unit 13c, and the AC input voltage detection unit 13d can be implemented in the form of software such as programs. Here, the controller 13 is an example of a “controller” as recited in the claims.

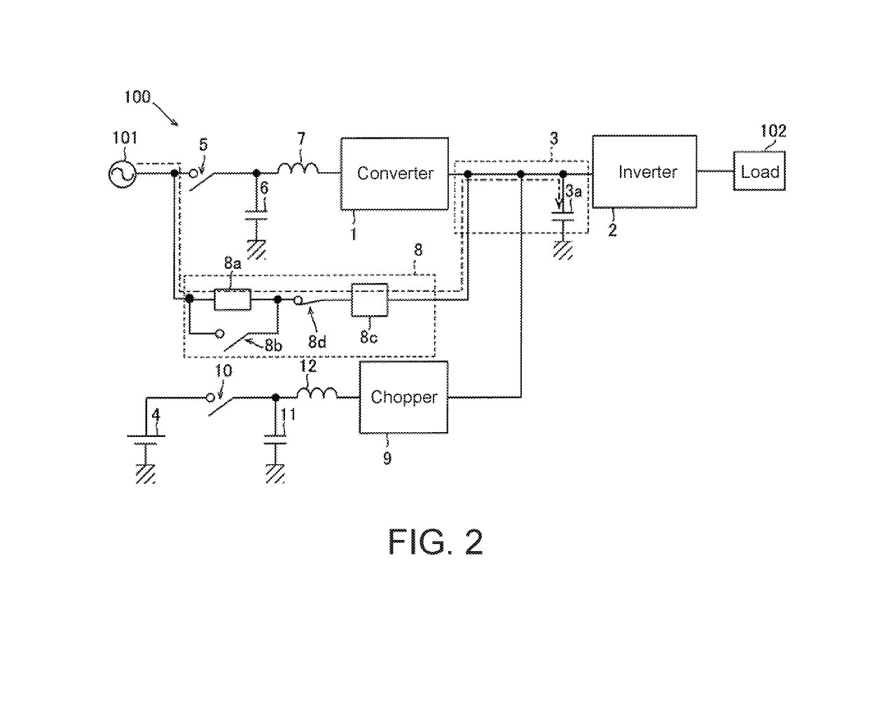

In the present embodiment, at startup, the controller 13 performs a control process to make the converter 1 convert DC voltage from the battery 4 to an AC voltage which then charges the input filter capacitor 6. Next, the control process performed during startup of the uninterruptible power supply 100 will be described in more detail with reference to FIGS. 2 to 7. Note that for simplicity, the controller 13 is not explicitly illustrated in FIGS. 2 to 7.

First, as illustrated in FIG. 2, when the uninterruptible power supply 100 is powered on, the controller 13 (see FIG. 1) uses the initial charging circuit 8 to initially charge the DC link capacitor 3a while maintaining the switch 5 in the OFF state. Here, the switch 5 and the switch 8b are OFF, and the switch 8d is ON. As a result, as illustrated by the dash-dotted arrow in FIG. 2, current flows from the AC power supply 101 through the charging resistor 8a, the switch 8d, and the rectifier 8c to the DC link circuit 3 (the DC link capacitor 3a). While this is happening, the rectifier 8c converts the AC voltage from the AC power supply 101 to a DC voltage.

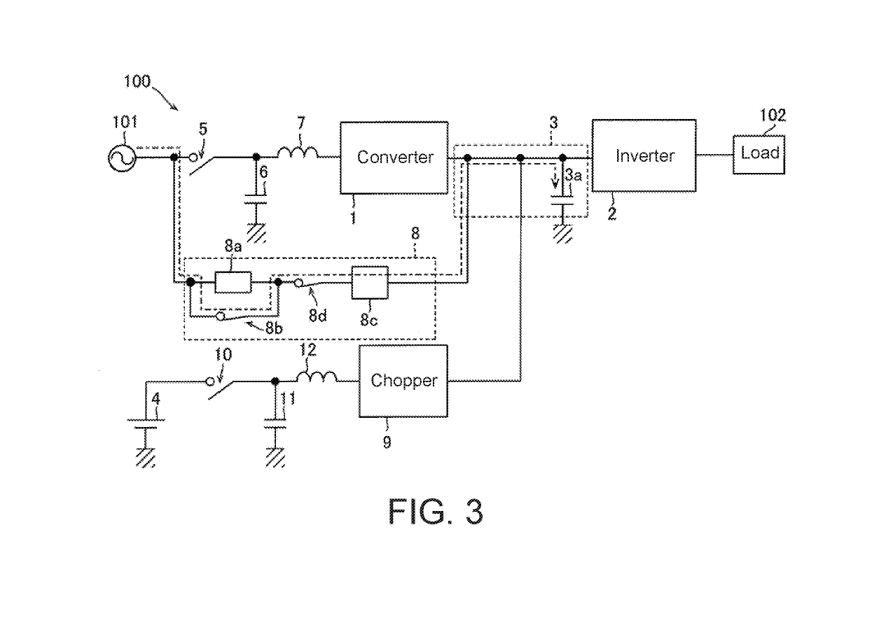

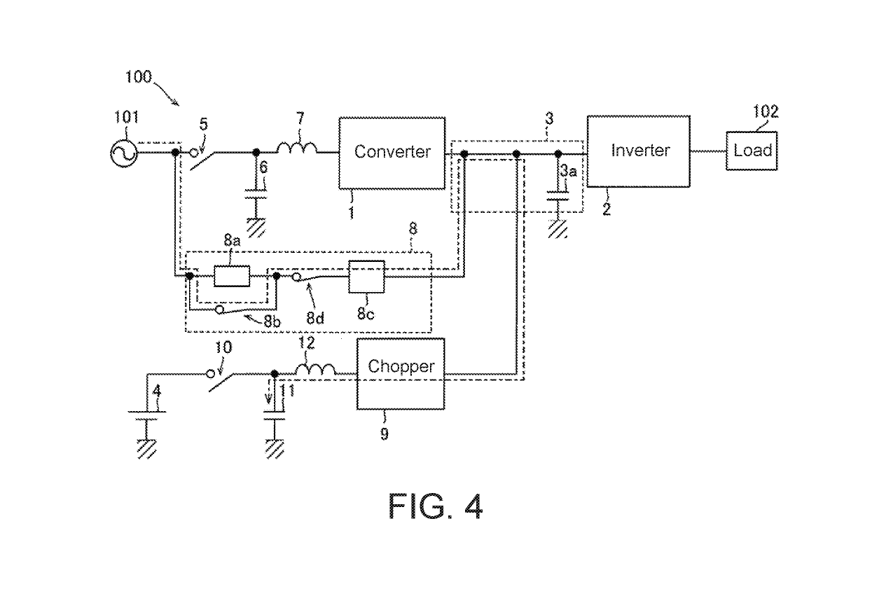

Next, in the present embodiment, as illustrated in FIGS. 3 and 4, the controller 13 (see FIG. 1) switches ON the switch 8b (see FIG. 3) and powers on the chopper 9 (see FIG. 4).

More specifically, as illustrated in FIG. 3, the controller 13 (see FIG. 1) switches ON the switch 8b once the voltage of the DC link capacitor 3a resulting from the initial charging by the initial charging circuit 8 becomes greater than or equal to a threshold voltage Vth1 (see FIG. 1). Even more specifically, the controller 13 (the sequence control unit 13a; see FIG. 1) switches ON the switch 8b once the voltage of the DC link circuit 3 (the DC link capacitor 3a) as detected by the controller 13 (the DC link voltage detection unit 13b; see FIG. 1) becomes greater than or equal to the threshold voltage Vth1. Here, the threshold voltage Vth1 is an example of a “prescribed threshold value” as recited in the claims.

As a result, as illustrated by the dash-dotted arrow in FIG. 3, current flows from the AC power supply 101 through the switch 8b, the switch 8d, and the rectifier 8c to the DC link circuit 3 and thus continues charging the DC link circuit 3 (the DC link capacitor 3a).

Next, as illustrated in FIG. 4, with the switch 8b still in the ON state, the controller 13 (the sequence control unit 13a; see FIG. 1) powers on the chopper 9. Here, as illustrated by the dash-dotted arrow in FIG. 4, once the chopper 9 is powered on, current flows from the AC power supply 101 through the switch 8b, the switch 8d, the rectifier 8c, the DC link circuit 3, the chopper 9, and the inductor 12 to the DC filter capacitor 11. As a result, the DC filter capacitor 11 gets charged.

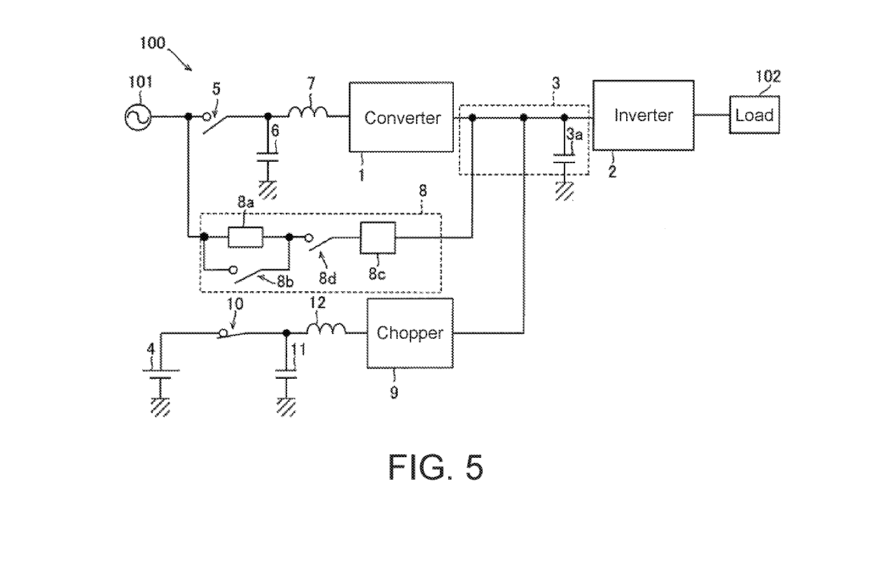

Next, in the present embodiment, as illustrated in FIG. 5, the controller 13 (see FIG. 1) switches ON the switch 10 while the DC filter capacitor 11 remains in a charged state. As a result, the output voltage of the chopper 9 which charges the DC filter capacitor 11 is controlled so as to become substantially equal to the output voltage of the battery 4.

More specifically, the controller 13 (the battery voltage detection unit 13c; see FIG. 1) detects the output voltage of the chopper 9 (to the DC filter capacitor 11) as well as the output voltage of the battery 4. If the output voltage of the chopper 9 and the output voltage of the battery 4 as detected by the controller 13 (the battery voltage detection unit 13c) are substantially equal to one another, the controller 13 (the sequence control unit 13a; see FIG. 1) switches ON the switch 10. Moreover, if the output voltage of the chopper 9 and the output voltage of the battery 4 are different from one another, the controller 13 controls the output voltage of the chopper 9 by adjusting the duty cycle of the chopper 9.

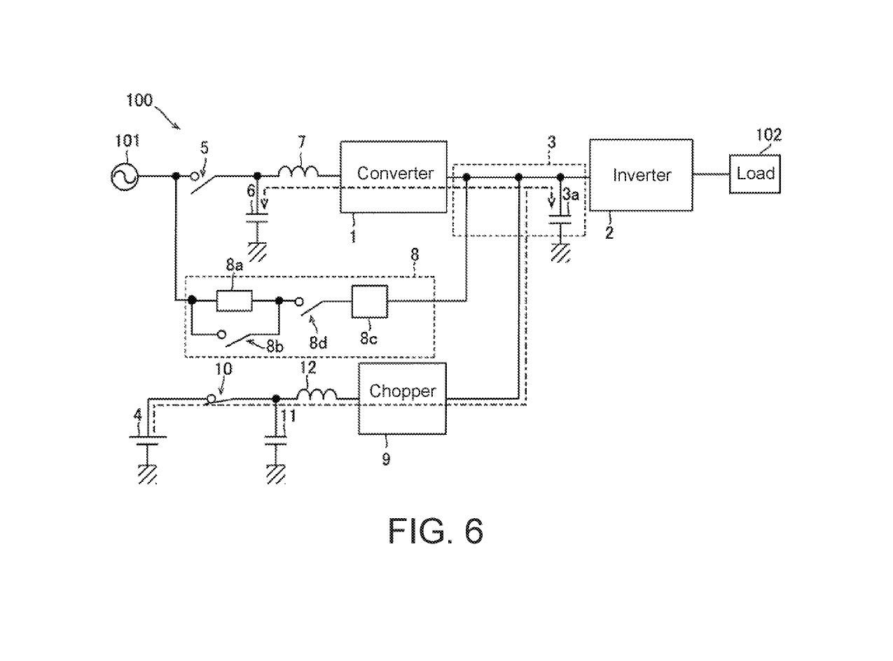

Next, in the present embodiment, as illustrated in FIG. 6, the controller 13 (see FIG. 1) connects the converter 1 to the battery 4 via the chopper 9 and sets the initial charging circuit 8 to a non-conducting state. More specifically, the controller 13 (the sequence control unit 13a; see FIG. 1) sets the initial charging circuit 8 to a non-conducting state by switching OFF the switch 8d and the switch 8b. Then, once the voltage of the DC link circuit 3 (the DC link capacitor 3a) as detected by the controller 13 (the DC link voltage detection unit 13b; see FIG. 1) becomes greater than or equal to a threshold voltage Vth2 (see FIG. 1), the controller 13 (the sequence control unit 13a) powers on the converter 1. Once the converter 1 is powered on, the DC voltage from the battery 4 is converted by the converter 1 to an AC voltage, which then charges the input filter capacitor 6.

Furthermore, in the present embodiment, the controller 13 uses the DC voltage from the battery 4 to charge the input filter capacitor 6 as well as to charge the DC link capacitor 3a. In other words, the DC link capacitor 3a, while being charged by the battery 4, is also discharged to charge the input filter capacitor 6. Here, as illustrated by the dash-dotted arrow in FIG. 6, current flows from the battery 4 through the switch 10, the inductor 12, the chopper 9, the converter 1, and the inductor 7 to the input filter capacitor 6. Moreover, as also illustrated by the dash-dotted arrow in FIG. 6, current also flows from the battery 4 through the switch 10, the inductor 12, and the chopper 9 to the DC link circuit 3.

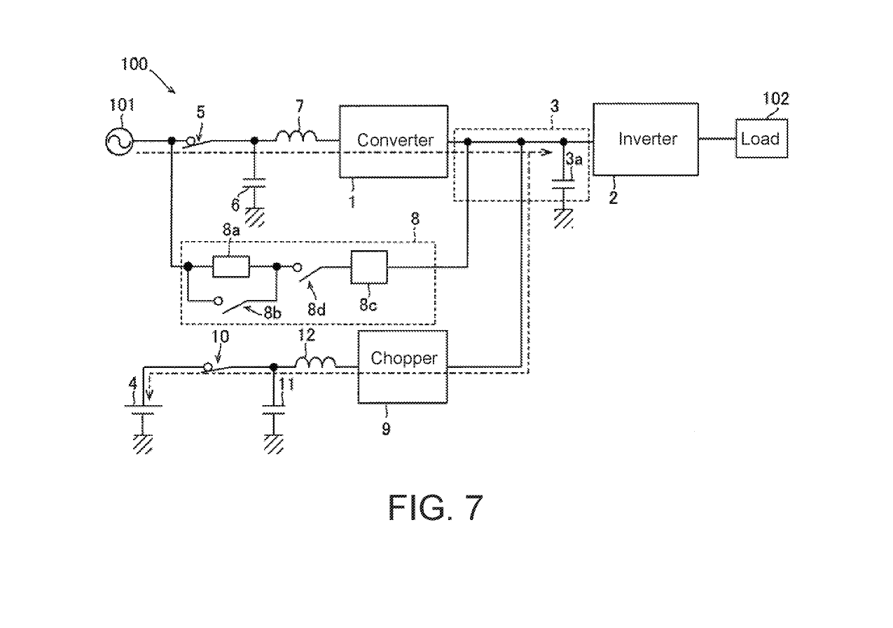

Next, in the present embodiment, as illustrated in FIG. 7, with the input filter capacitor 6 in a charged state, the controller 13 (see FIG. 1) switches ON the switch 5 and uses the AC voltage from the AC power supply 101 to charge the battery 4. Here, as illustrated by the dash-dotted arrow in FIG. 7, current flows from the AC power supply 101 through the switch 5, the inductor 7, the converter 1, the DC link circuit 3, the chopper 9, the inductor 12, and the switch 10 to the battery 4.

Furthermore, in the present embodiment, the controller 13 makes the phase and amplitude of the AC voltage from the converter 1 that charges the input filter capacitor 6 be substantially equal to the phase and amplitude of the AC voltage from the AC power supply 101. Then, once the phase and amplitude of the AC voltage from the converter 1 are substantially equal to the phase and amplitude of the AC voltage from the AC power supply 101, the switch 5 is switched ON.

More specifically, the controller 13 (the AC input voltage detection unit 13d; see FIG. 1) detects the AC voltage from the converter 1 and the AC voltage from the AC power supply 101. When the phase and amplitude of the AC voltage from the converter 1 as detected by the controller 13 (the AC input voltage detection unit 13d; see FIG. 1) are respectively equal to the phase and amplitude of the AC voltage from the AC power supply 101, the controller 13 (the sequence control unit 13a; see FIG. 1) switches ON the switch 5. Moreover, if the phase and amplitude of the AC voltage from the converter 1 are respectively different from the phase and amplitude of the AC voltage from the AC power supply 101, the controller 13 controls the AC voltage from the converter 1 by adjusting the duty cycle of the converter 1.

Finally, the controller 13 (the sequence control unit 13a) powers on the inverter 2, at which point normal operation of the uninterruptible power supply 100 begins.

(Control Flow During Startup of Uninterruptible Power Supply)

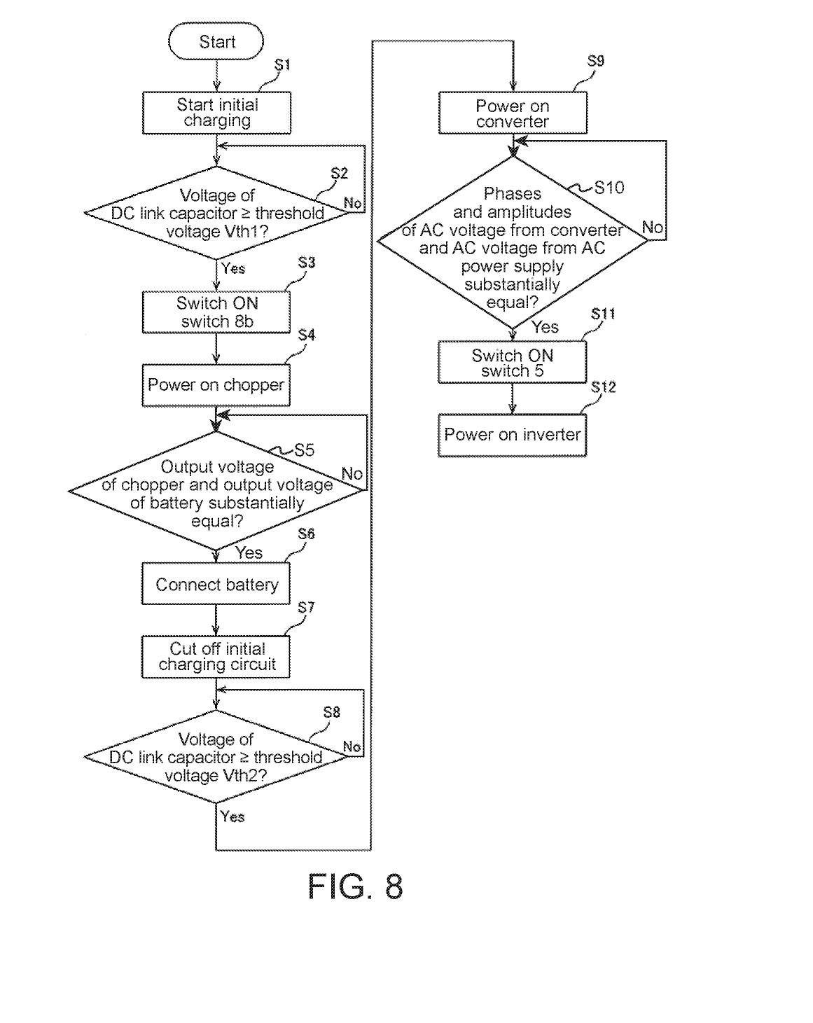

Next, the flow of the control process performed by the controller 13 of the uninterruptible power supply 100 according to the present embodiment during startup of the uninterruptible power supply 100 will be described with reference to FIG. 8.

First, in step S1, initial charging by the initial charging circuit 8 is started. Here, the switch 8d is switched ON.

Next, in step S2, it is determined whether the voltage of the DC link capacitor 3a is greater than or equal to the threshold voltage Vth1. If the voltage of the DC link capacitor 3a is greater than or equal to the threshold voltage Vth1, the process proceeds to step S3. If the voltage of the DC link capacitor 3a is less than the threshold voltage Vth1, step S2 is repeated until the voltage of the DC link capacitor 3a becomes greater than or equal to the threshold voltage Vth1.

Next, in step S3, the switch 8b is switched ON. Then, the chopper 9 is powered on.

Next, in step S5, it is determined whether the output voltage of the chopper 9 (to the DC filter capacitor 11) and the output voltage of the battery 4 are substantially equal. If the output voltage of the chopper 9 and the output voltage of the battery 4 are substantially equal, the process proceeds to step S6. Meanwhile, if the output voltage of the chopper 9 and the output voltage of the battery 4 are different from one another, step S5 is repeated until the output voltage of the chopper 9 and the output voltage of the battery 4 become substantially equal.

Next, in step S6, the switch 10 is switched ON to connect together the battery 4 and the chopper 9. Then, in step S7, the switch 8d and the switch 8b are switched OFF to cut off the initial charging circuit 8 and set the initial charging circuit 8 to a non-conducting state.

Next, in step S8, first, control of the DC link voltage by the chopper 9 is started. In other words, it is determined whether the voltage of the DC link capacitor 3a is greater than or equal to the threshold voltage Vth2. If the voltage of the DC link capacitor 3a is greater than or equal to the threshold voltage Vth2, the process proceeds to step S9. If the voltage of the DC link capacitor 3a is less than the threshold voltage Vth2, step S8 is repeated until the voltage of the DC link capacitor 3a becomes greater than or equal to the threshold voltage Vth2.

Next, in step S9, the converter 1 is powered on.

Then, in step S10, it is determined whether the respective phases and amplitudes of the AC voltage from the converter 1 (which gets output to the input filter capacitor 6) and the AC voltage from the AC power supply 101 are substantially equal. If the respective phases and amplitudes of the AC voltage from the converter 1 and the AC voltage from the AC power supply 101 are substantially equal, the process proceeds to step S11. If the respective phases and amplitudes are different from one another, step S10 is repeated until the phases and amplitudes become substantially equal.

Next, in step S11, the switch 5 is switched ON to connect together the AC power supply 101 and the converter 1. As a result, the battery 4 is charged by the voltage of the AC power supply 101.

Finally, in step S12, the inverter 2 is powered on to start normal operation of the uninterruptible power supply 100.

### Effects of Present Embodiment

The present embodiment makes it possible to achieve advantageous effects such as the following.

As described above, in the present embodiment the uninterruptible power supply 100 is configured to include the controller 13, which, during startup, maintains the switch 5 in the OFF state, uses the initial charging circuit 8 to initially charge the DC link capacitor 3a, and thereafter uses the converter 1 to convert DC voltage from the battery 4 to AC voltage which then charges the input filter capacitor 6. Thus, during startup, the input filter capacitor 6 can be charged using the battery 4. As a result, when the AC power supply 101 and the input filter capacitor 6 are connected together by switching ON the switch 5, the input filter capacitor 6 has already been charged by the voltage of the battery 4, which makes it possible to reduce the voltage difference between the voltage of the input filter capacitor 6 and the voltage of the AC power supply 101. This makes it possible to prevent inrush current from the AC power supply 101 to the input filter capacitor 6 when the AC power supply 101 and the input filter capacitor 6 are connected together by switching ON the switch 5. This, in turn, makes it possible to reduce the occurrence of inrush current-induced effects on operation of the AC power supply 101 itself as well as on operation of any electronic devices connected to the AC power supply 101. Here, when the input filter capacitor 6 is charged by the AC voltage, the input filter capacitor 6 is alternately charged and discharged in a repeated, periodic manner. Thus, “charging the input filter capacitor 6 using an AC voltage” refers to this repeated periodic charging.

Moreover, as described above, in the present embodiment, the uninterruptible power supply 100 is configured such that the controller 13 switches ON the switch 8b, and powers on the chopper 9 so that current flows from the AC power supply 101 through the switch 8b, the switch 8d, the rectifier 8c, the DC link circuit 3, the chopper 9, and the inductor 12 to the DC filter capacitor 11. As a result, the DC filter capacitor 11 gets charged. This allows the current that flows when the chopper 9 is powered on to flow more easily through the switch 8b than through the charging resistor 8a, thereby making it possible to reduce the amount of current that flows through the charging resistor 8a in comparison to when the switch 8b is not present. This, in turn, makes it possible to prevent damage (burnout) of the charging resistor 8a due to current flowing therethrough.

Furthermore, as described above, in the present embodiment the uninterruptible power supply 100 is configured such that the controller 13 switches ON the switch 8b, powers on the chopper 9 to charge the DC filter capacitor 11, and, once the DC filter capacitor 11 has been charged, switches ON the switch 10 and uses the converter 1 to convert DC voltage from the battery 4 to AC voltage which then charges the input filter capacitor 6. Here, switching ON the switch 10 only after the DC filter capacitor 11 has been charged makes it possible to prevent flow of inrush current from the battery 4 to the DC filter capacitor 11 when the switch 10 is switched ON. This, in turn, makes it possible to prevent damage (burnout or the like) of the DC filter capacitor 11.

In addition, as described above, in the present embodiment the uninterruptible power supply 100 is configured such that the controller 13 switches ON the switch 8b and also powers on the chopper 9 once the voltage of the DC link capacitor 3a resulting from the initial charging by the initial charging circuit 8 becomes greater than or equal to the threshold voltage Vth1. Here, switching ON the switch 8b allows the current that flows when the chopper 9 is powered on to flow more easily through the switch 8b than through the charging resistor 8a. This makes it possible to reduce the amount of current that flows through the charging resistor 8a in comparison to when the switch 8b is not present, thereby making it possible to prevent the charging resistor 8a from being damaged (burnt out) by the current flowing therethrough when the voltage of the DC link capacitor 3a becomes greater than or equal to the threshold voltage Vth1.

Moreover, as described above, in the present embodiment the uninterruptible power supply 100 is configured such that the controller 13 connects together the converter 1 and the battery 4 via the chopper 9, sets the initial charging circuit 8 to a non-conducting state, and uses the converter 1 to convert DC voltage from the battery 4 to AC voltage which then charges the input filter capacitor 6. Here, setting the initial charging circuit 8 to a non-conducting state makes it possible to prevent the current that flows from the battery 4 to the converter 1 from flowing to the AC power supply 101 through the initial charging circuit 8.

Furthermore, as described above, in the present embodiment the uninterruptible power supply 100 is configured such that the controller 13 uses DC voltage from the battery 4 to both charge the input filter capacitor 6 and charge the DC link capacitor 3a. This makes it possible to prevent the charge of the DC link capacitor 3a from decreasing when the input filter capacitor 6 is charged using DC voltage from the DC link capacitor 3a.

In addition, as described above, in the present embodiment the uninterruptible power supply 100 is configured such that the controller 13 makes the phase and amplitude of the AC voltage from the converter 1 that charges the input filter capacitor 6 be substantially equal to the phase and amplitude of the AC voltage from the AC power supply 101. As a result, the voltage difference (amplitude difference and phase difference) between the AC voltage from the converter 1 (the voltage of the input filter capacitor 6) and the AC voltage from the AC power supply 101 becomes substantially equal to zero, thereby making it possible to reliably prevent flow of inrush current from the AC power supply 101 to the input filter capacitor 6.

Moreover, as described above, in the present embodiment the uninterruptible power supply 100 is configured such that the controller 13, once the input filter capacitor 6 has been charged, switches ON the switch 5 and uses the AC voltage from the AC power supply 101 to charge the battery 4. This makes it possible to prevent inrush current from flowing to the input filter capacitor 6 when the switch 5 is switched ON, thereby making it possible to reduce the occurrence of any effects on operation of the AC power supply 101 itself. This, in turn, allows the battery 4 to be appropriately charged by the AC power supply 101.

### MODIFICATION EXAMPLES

It should be noted that in all respects, the embodiment described above is only an example and does not limit the present invention in any way. The scope of the present invention is defined by the claims, not by the description of the embodiment above. Furthermore, the scope of the present invention also includes all changes (modification examples) made within the scope of the claims and their equivalents.

For example, although the embodiment above was described as including the second switch (the switch 8b), the present invention is not limited to this example. The second switch does not necessarily need to be included, for example. In this case, in order to prevent damage (burnout) of the charging resistor, it is preferable that the power rating and resistance of the charging resistor be selected appropriately.

Moreover, although in the embodiment above the switch 5, the switch 8b, the switch 10, and the switch 8d were described as being magnetic contactors, the present invention is not limited to this example. For example, the switch 5, the switch 8b, the switch 10, and the switch 8d may be relays, breakers, or the like.

Furthermore, although in the embodiment above the voltage of the DC link capacitor is detected by the controller (the controller 13) and the second switch (the switch 8b) is switched ON once the detected voltage is greater than or equal to the prescribed threshold value (the threshold voltage Vth1), the present invention is not limited to this example. For example, as an alternative to detecting the voltage of the DC link capacitor directly, the second switch (the switch 8b) may instead be switched ON once a prescribed time has elapsed from when initial charging of the DC link capacitor begins.

In addition, although in the embodiment above the voltage of the DC link capacitor is detected by the controller (the controller 13) and the converter is powered on once the detected voltage is greater than or equal to the threshold voltage Vth2, the present invention is not limited to this example. For example, as an alternative to detecting the voltage of the DC link capacitor directly, the converter may instead be powered on once a prescribed time has elapsed from when the third switch (the switch 10) is switched ON and the DC link capacitor begins to be charged by the electrical storage unit (the battery 4).

Moreover, although in the embodiment above the initial charging circuit 8 is set to a non-conducting state after the electrical storage unit (the battery 4) is connected to the chopper, the present invention is not limited to this example. For example, the initial charging circuit 8 may be set to a non-conducting state at the same time that the electrical storage unit (the battery 4) is connected to the chopper, or the initial charging circuit 8 may be set to a non-conducting state before the electrical storage unit (the battery 4) is connected to the chopper.

Furthermore, although for purposes of simplifying the description the process performed by the controller (the controller 13) of the present invention in the above embodiment was described using a flowchart in a flow-based operational manner in which operations are performed in order according to a given process flow, the present invention is not limited to this example. In the present invention, the operations of the controller (the controller 13) may be performed in an event-driven operational manner in which operations are performed on a per-event basis. In this case, the process may be implemented as a completely event-driven process or may be implemented as a combination of event-driven and flow-based processes.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. An uninterruptible power supply, comprising:
a converter that receives an AC voltage from an AC power supply at an input node and converts the AC voltage to a DC voltage;
an inverter that converts the DC voltage from the converter to an AC voltage and supplies that AC voltage to a load;
a DC link circuit that includes a DC link capacitor and is arranged between the converter and the inverter;
an electrical storage unit that is connected to the DC link circuit so as to supply power to the load through the inverter when the AC power supply is abnormal;
a first switch arranged between the input node of the converter to be connected to the AC power supply and the converter;
an input filter capacitor connected between the first switch and the converter;
an initial charging circuit that is connected in parallel to the first switch and the converter to charge the DC link capacitor of the DC link circuit; and
a controller that, during startup, turns OFF the first switch, activates the initial charging circuit to initially charge the DC link capacitor, and thereafter activates the converter to convert DC voltage from the electrical storage unit to AC voltage so as to charge the input filter capacitor while the first switch is maintained in an OFF state.

2. The uninterruptible power supply according to claim 1, further comprising:
a chopper arranged between the DC link circuit and the electrical storage unit,
wherein the initial charging circuit includes a charging resistor and a second switch connected in parallel to the charging resistor, and
wherein the controller switches ON the second switch and powers on the chopper so that current flows from the AC power supply towards the electrical storage unit.

3. The uninterruptible power supply according to claim 2, further comprising:
a third switch arranged between the chopper and the electrical storage unit; and
a DC filter capacitor connected between the third switch and the chopper,
wherein the controller turns ON the second switch and powers on the chopper to charge the DC filter capacitor, and when the DC filter capacitor has been charged, switches ON the third switch, and the controller thereafter activates the converter to convert DC voltage from the electrical storage unit to AC voltage so as to charge the input filter capacitor.

4. The uninterruptible power supply according to claim 2, wherein the controller turns ON the second switch and powers on the chopper when a voltage of the DC link capacitor resulting from the initial charging by the initial charging circuit becomes greater than or equal to a prescribed threshold value.

5. The uninterruptible power supply according to claim 3, wherein the controller turns ON the second switch and powers on the chopper when a voltage of the DC link capacitor resulting from the initial charging by the initial charging circuit becomes greater than or equal to a prescribed threshold value.

6. The uninterruptible power supply according to claim 2, wherein the controller causes the converter and the electrical storage unit to be connected via the chopper, deactivates the initial charging circuit, and activates the converter to convert DC voltage from the electrical storage unit to AC voltage so as to charge the input filter capacitor.

7. The uninterruptible power supply according to claim 3, wherein when activating the converter to convert the DC voltage from the electrical storage unit to the AC voltage so as to charge the input filter capacitor, the controller also causes the DC voltage from the electrical storage unit to charge the DC link capacitor.

8. The uninterruptible power supply according to claim 3, wherein when activating the converter to convert the DC voltage from the electrical storage unit to the AC voltage so as to charge the input filter capacitor, the controller causes a phase and amplitude of the AC voltage from the converter that charges the input filter capacitor to be substantially equal to a phase and amplitude of the AC voltage from the AC power supply.

9. The uninterruptible power supply according to claim 1, wherein once the input filter capacitor has been charged, the controller turns ON the first switch and causes the AC voltage from the AC power supply to charge the electrical storage unit.

10. The uninterruptible power supply according to claim 1, wherein when activating the converter to convert the DC voltage from the electrical storage unit to the AC voltage so as to charge the input filter capacitor, the controller causes a phase and amplitude of the AC voltage from the converter that charges the input filter capacitor to be substantially equal to a phase and amplitude of the AC voltage from the AC power supply, and when the input filter capacitor has been charged and when the phase and amplitude of the AC voltage from the converter that charges the input filter capacitor become substantially equal to the phase and amplitude of the AC voltage from the AC power supply, the controller turns ON the first switch and causes the AC voltage from the AC power supply to charge the electrical storage unit.

11. The uninterruptible power supply according to claim 2, wherein when activating the converter to convert the DC voltage from the electrical storage unit to the AC voltage so as to charge the input filter capacitor, the controller causes a phase and amplitude of the AC voltage from the converter that charges the input filter capacitor to be substantially equal to a phase and amplitude of the AC voltage from the AC power supply, and when the input filter capacitor has been charged and when the phase and amplitude of the AC voltage from the converter that charges the input filter capacitor become substantially equal to the phase and amplitude of the AC voltage from the AC power supply, the controller turns ON the first switch and causes the AC voltage from the AC power supply to charge the electrical storage unit.

12. The uninterruptible power supply according to claim 3, wherein when activating the converter to convert the DC voltage from the electrical storage unit to the AC voltage so as to charge the input filter capacitor, the controller causes a phase and amplitude of the AC voltage from the converter that charges the input filter capacitor to be substantially equal to a phase and amplitude of the AC voltage from the AC power supply, and when the input filter capacitor has been charged and when the phase and amplitude of the AC voltage from the converter that charges the input filter capacitor become substantially equal to the phase and amplitude of the AC voltage from the AC power supply, the controller turns ON the first switch and causes the AC voltage from the AC power supply to charge the electrical storage unit.
